(19) United States
(12) Patent Application Publication
(10) Pub. No.: US 2026/0267483 A1
(43) Pub. Date: Sep. 10, 2026

(54) INFORMATION PROCESSING APPARATUS, METHOD FOR CONTROLLING INFORMATION PROCESSING APPARATUS, RECORDING MEDIUM, AND INFORMATION PROCESSING SYSTEM

(71) Applicant: CANON KABUSHIKI KAISHA, Tokyo (JP)

(72) Inventor: SOSUKE KAGAYA, Tokyo (JP)

(21) Appl. No.: 19/554,271

(22) Filed: Mar. 2, 2026

(30) Foreign Application Priority Data
Mar. 6, 2025 (JP) 2025-035105

(51) Int. Cl. G06F 3/0484; G06F 3/0482; H04M 1/72436

(52) U.S. Cl. CPC G06F 3/0484; G06F 3/0482; H04M 1/72436; H04M 2201/42

(57) ABSTRACT

An information processing apparatus that connects to a plurality of upload destinations includes one or more memories storing instructions, and one or more processors that, upon execution of the stored instructions, is configured to: acquire a plurality of files uploaded from the information processing apparatus to upload destinations and upload log information about upload dates and the upload destinations of the plurality of files, perform control such that, in a case where an instruction to display an upload log list is issued, the upload log list is displayed based on the acquired upload log information, and perform control such that files having a matching combination of a upload date and a upload destination are grouped into a same group and the upload log list including a plurality of groups having different upload destinations is displayed on a display.

### BACKGROUND

### Field of the Technology

The present disclosure relates to an information processing apparatus, a method for controlling the information processing apparatus, a recording medium, and an information processing system.

### Description of the Related Art

An information processing apparatus, such as a smartphone, may transmit an image file or the like captured and recorded by an image capturing apparatus, such as a digital camera, connected to the information processing apparatus to an external server using an application in the information processing apparatus.

Japanese Patent Laid-Open No. 2024-162118 describes an image transmission apparatus configured to determine a transmission order based on factors such as a transmission time, an encoding method, a modulation method, the number of retransmissions, and the number of times that a communication speed decreases, when transmitting image data to a plurality of transmission destinations.

In conventional image transmission apparatuses, improvement is needed with respect to the usability when reviewing an upload log.

### SUMMARY

The present disclosure is directed to realizing a technology capable of improving usability when reviewing an upload log. According to an aspect of the present disclosure, an information processing apparatus that connects to a plurality of upload destinations includes one or more memories storing instructions, and one or more processors that, upon execution of the stored instructions, is configured to: acquire a plurality of files uploaded from the information processing apparatus to upload destinations and upload log information about upload dates and the upload destinations of the plurality of files, perform control such that, in a case where an instruction to display an upload log list is issued, the upload log list is displayed based on the acquired upload log information, and perform control such that files having a matching combination of a upload date and a upload destination are grouped into a same group and the upload log list including a plurality of groups having different upload destinations is displayed on a display.

Features of the present disclosure will become apparent from the following description of embodiments with reference to the attached drawings. The following description of embodiments is described by way of example.

### BRIEF DESCRIPTION OF THE DRAWINGS

FIG. 1 is a conceptual diagram illustrating a configuration of an information processing system.

FIGS. 2A to 2C are diagrams illustrating a configuration of a digital camera as an example of an image capturing apparatus.

FIGS. 3A and 3B are diagrams illustrating a configuration of a smartphone as an example of an information processing apparatus.

FIG. 4 is a diagram illustrating a data format of upload log information.

FIGS. 5A to 5F are schematic diagrams illustrating display states and functions of operation screens of a camera communication application.

FIG. 6 is a diagram illustrating a process sequence in which an image file is uploaded from the digital camera to the server via the smartphone.

FIG. 7 is a diagram illustrating a process flow in which an image file is uploaded from the digital camera to the server via the smartphone.

FIG. 8 is a diagram illustrating a process sequence in which an image file is uploaded from the smartphone to the server.

FIG. 9 is a diagram illustrating a process flow in which an image file is uploaded from the smartphone to the server.

FIG. 10 is a diagram illustrating a process flow in which an upload destination is set.

FIG. 11 is a diagram illustrating a process sequence in which an image file is re-uploaded from an upload log screen.

FIG. 12 is a diagram illustrating a process flow in which an image file is re-uploaded from the upload log screen.

### DESCRIPTION OF THE EMBODIMENTS

Hereinafter, embodiments for implementing the present disclosure will be described in detail with reference to the accompanying drawings.

It should be noted that the embodiments described below are merely examples of means for realizing the present disclosure, and may be appropriately modified or changed depending on the configuration of the apparatus to which the present disclosure is applied and various conditions. Furthermore, the respective embodiments may also be combined as appropriate.

### Configuration of an Information Processing System 1

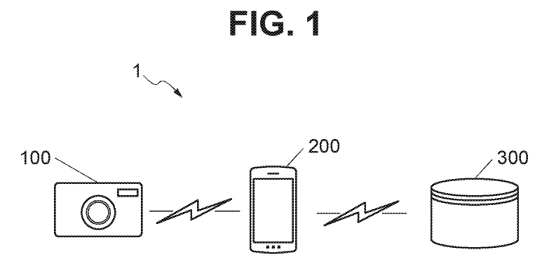

FIG. 1 is a conceptual diagram illustrating a configuration of an information processing system 1. In FIG. 1, an image capturing apparatus 100 is a digital camera. An information processing apparatus 200, such as a smartphone or a computer, includes a communication function. A server 300 is an image accumulation apparatus (external apparatus) at a connection destination accessible via a communication network, such as the Internet. Herein, an upload destination (transmission destination) refers to a destination to which an image file is uploaded, and includes a server and an external apparatus.

In FIG. 1, the digital camera 100 and the smartphone 200 are connected via wired or wireless communication using a wired cable or a connection method, such as Wi-Fi. Further, an image file captured and recorded by the digital camera 100 can be transferred to the smartphone 200. The smartphone 200 and the server 300 are connected using a communication method, such as mobile data communication, and information saved on the smartphone 200 can be transferred to the server 300 via communication, such as the File Transfer Protocol (FTP).

The configuration of the information processing system 1 is not limited to the above-described configuration. For example, the digital camera 100, the smartphone 200, and the server 300 may be connected to the same network via an access point to realize a file transfer process between the digital camera 100, the smartphone 200, and the server 300 without using mobile data communication.

### Configuration of the Digital Camera 100

### Hardware Configuration

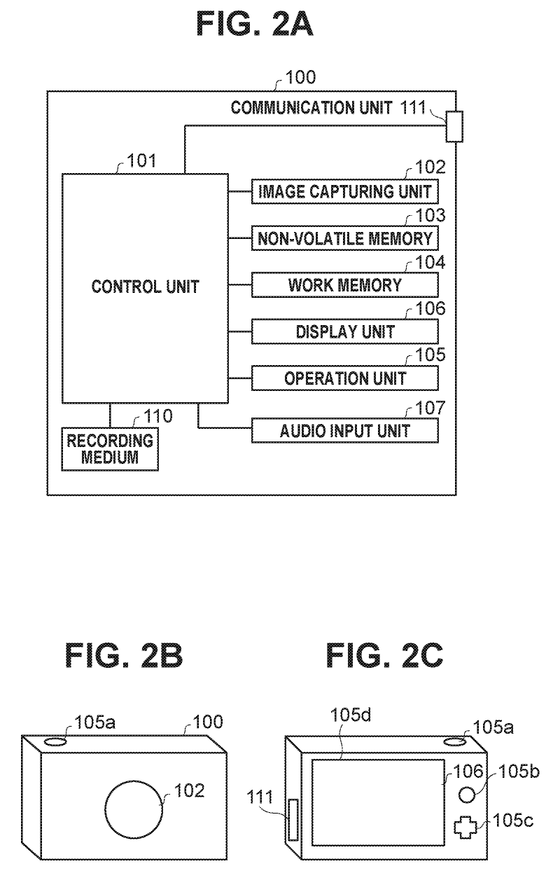

FIG. 2A is a block diagram illustrating an example of a hardware configuration of the digital camera 100.

While the digital camera 100 is described herein as an example of the image capturing apparatus, the image capturing apparatus is not limited to a digital camera. For example, the image capturing apparatus may be an information processing apparatus, such as a mobile media player, a so-called tablet device, or a personal computer.

A control unit 101 controls each component of the digital camera 100 based on an input signal or a program described below. A plurality of hardware components may control the entire apparatus by distributing processes, rather than the control unit 101 controlling the entire apparatus.

An image capturing unit 102 includes, for example, an optical lens unit, an optical system, an image sensor, and the like. The optical system controls aperture, zoom, focus, and the like. The image sensor converts light (optical image) received via the optical lens unit into an electrical image signal. A complementary metal oxide semiconductor (CMOS) or a charge-coupled device (CCD) is commonly used as the image sensor. The image capturing unit 102 is controlled by the control unit 101, thereby converting subject light formed by the lens of the image capturing unit 102 into an electrical signal via the image sensor, performing a noise reduction process and the like, and outputting digital data as image data. The digital camera 100 according to the present embodiment records the image data in a recording medium 110.

A non-volatile memory 103 is electrically erasable and recordable and stores a below-described program configured to be executed by the control unit 101, metatemplate information, and the like.

A work memory 104 is used as a buffer memory for temporarily holding moving image data captured by the image capturing unit 102, a memory for displaying an image on a display unit 106, a work area of the control unit 101, and the like.

An operation unit 105 is used to receive an instruction from a user to the digital camera 100. For example, the operation unit 105 includes a power button, a release switch, and a reproduction button. The power button is used by the user to issue an instruction to turn on/off a power supply of the digital camera 100. The release switch is used by the user to issue an instruction to start/stop image capturing. The reproduction button is used by the user to issue an instruction to reproduce image data. The operation unit 105 further includes an operational member, such as a dedicated connection button, for starting communication with an information processing apparatus, such as the smartphone 200, via a communication unit 111, which will be described below. Further, the operation unit 105 also includes a touch panel formed on the display unit 106, which will be described below.

The display unit 106 displays a live view image during image capturing, displays captured image data, displays text for interactive operation, and displays other information. The display unit 106 is not necessarily required to be provided in the digital camera 100. The digital camera 100 may be connected to the internal or external display unit 106, and it is sufficient that the digital camera 100 includes at least a display control function to control the display on the display unit 106.

An audio input unit 107 is a device configured to input audio information, and audio data converted from audio information by the audio input unit 107 is recorded in an audio file format on the recording medium 110.

The recording medium 110 is configured to record image data output from the image capturing unit 102 and audio data output from the audio input unit 107. The recording medium 110 may be configured to be attachable to and detachable from the digital camera 100 or may be provided in the digital camera 100.

In other words, it is sufficient that the digital camera 100 at least includes a unit configured to access the recording medium 110.

The communication unit 111 is an interface configured to connect to an external information processing apparatus. The digital camera 100 according to the present embodiment is configured to exchange data with an external information processing apparatus via the communication unit 111. For example, image data generated by the image capturing unit 102 and audio data generated by the audio input unit 107 may be transmitted to an external information processing apparatus via the communication unit 111. According to the present embodiment, the communication unit 111 includes an interface configured to communicate with an external information processing apparatus via a so-called wireless local area network (wireless LAN) based on the Institute of Electrical and Electronics Engineers (IEEE) 802.11 standard. The communication unit 111 further includes a Universal Serial Bus (USB) interface configured to communicate with an external information processing apparatus via a USB cable. The control unit 101 controls the communication unit 111, thereby realizing wireless and wired communications with an external information processing apparatus.

The communication unit 111 of the digital camera 100 according to the present embodiment includes an access point mode (hereinafter, “AP mode”) in which the communication unit 111 operates as an access point in an infrastructure mode. The communication unit 111 further includes a client mode (hereinafter, “CL mode”) in which the communication unit 111 operates as a client in the infrastructure mode. By causing the communication unit 111 to operate in the CL mode, the digital camera 100 according to the present embodiment may operate as a client (CL) device in the infrastructure mode. In a case where the digital camera 100 operates as a CL device, the digital camera 100 may connect to a nearby AP device, thereby participating in a network formed by the AP device. Further, by causing the communication unit 111 to operate in the AP mode, the digital camera 100 according to the present embodiment may operate as a simplified AP (hereinafter, “simplified AP”), which is a type of AP with a limited function. In a case where the digital camera 100 operates as a simplified AP, the digital camera 100 itself forms a network. A device near the digital camera 100 recognizes the digital camera 100 as an AP device and may participate in the network formed by the digital camera 100. As described above, a program configured to cause the digital camera 100 to operate is held in the non-volatile memory 103.

The digital camera 100 according to the present embodiment is a simplified AP that is a type of AP but does not include a gateway function that transfers data received from a CL device to an Internet provider or the like. Accordingly, the digital camera 100 may receive data from another device participating in the network formed by the digital camera 100 but cannot transfer the received data to a network such as the Internet.

### Exterior

Next, an exterior of the digital camera 100 will be described. FIGS. 2B and 2C are diagrams illustrating an example of an exterior of the digital camera 100. A release switch 105a, a reproduction button 105b, a direction key 105c, and a touch panel 105d are operational members included in the operation unit 105. Further, an image obtained as a result of image capturing performed by the image capturing unit 102 is displayed on the display unit 106. The communication unit 111 is an interface configured to connect to an external information processing apparatus.

### Configuration of the Smartphone 200

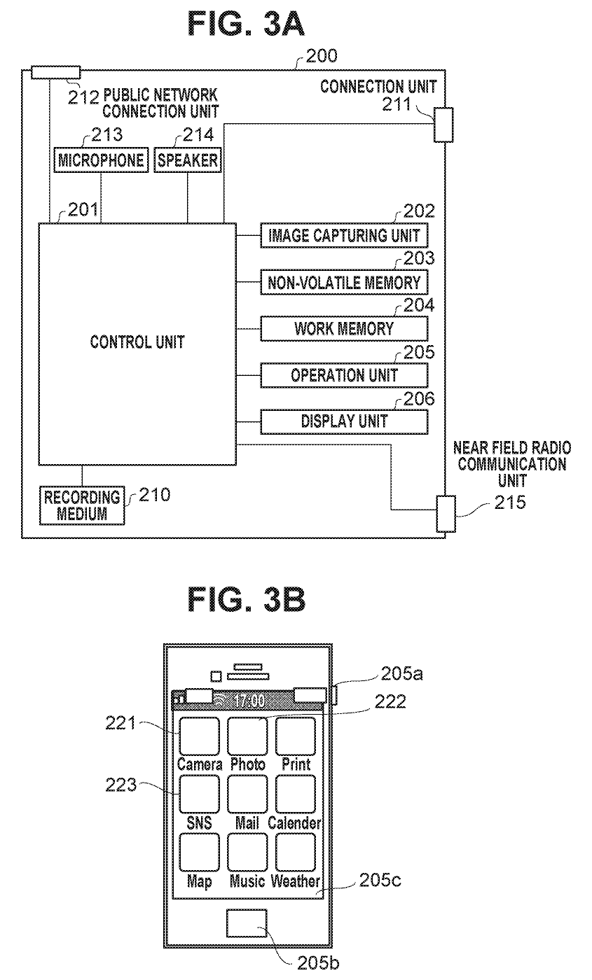

FIG. 3A is a block diagram illustrating an example of a configuration of the smartphone 200 as an example of an information processing apparatus. While a smartphone is described herein as an example of an information processing apparatus, the information processing apparatus is not limited to a smartphone. For example, the information processing apparatus may be a digital camera with a wireless function, a mobile media player, a so-called tablet device, a personal computer, a smartphone, or the like.

A control unit 201 controls each component of the smartphone 200 based on an input signal or a program described below. A plurality of hardware components may control the entire apparatus by distributing processes, rather than the control unit 201 controlling the entire apparatus.

An image capturing unit 202 converts subject light formed by a lens of the image capturing unit 202 into an electrical signal, performs a noise reduction process and the like, and outputs digital data as image data. The captured image data is buffered in a buffer memory, and thereafter the control unit 201 performs a predetermined calculation. Then, the data is recorded on a recording medium 210.

A non-volatile memory 203 is electrically erasable and recordable and stores an operating system (OS), which is the basic software configured to be executed by the control unit 201, various programs, and the like. A program for communicating with the digital camera 100 is held in the non-volatile memory 203 and installed as a camera communication application. A process of the smartphone 200 according to the present embodiment is realized by reading a program provided by the camera communication application. The camera communication application includes a program for using a basic function (such as a wireless LAN function, a Bluetooth® function, and/or a function that invokes another application) of the OS installed in the smartphone 200. Further, the camera communication application includes a remote image capturing function that captures an image by remotely operating the digital camera 100 using the smartphone 200 while viewing a live view image from the digital camera 100 on the smartphone 200. Furthermore, the camera communication application includes a remote browsing function that remotely browses image data recorded on a recording medium attached to the digital camera 100 and receives the image data.

The OS of the smartphone 200 may include a program configured to realize a process according to the present embodiment.

A work memory 204 is used as a buffer memory for temporarily saving image data generated by the image capturing unit 202, a memory for displaying an image on a display unit 206, a work area of the control unit 201, and the like.

An operation unit 205 is used to receive an instruction from the user to the smartphone 200. For example, the operation unit 205 includes a power button and an operational member such as a touch panel formed on the display unit 206. The power button is used by the user to issue an instruction to turn on/off a power supply of the smartphone 200.

The display unit 206 displays image data, text for interactive operation, and the like. The display unit 206 is not necessarily required to be provided in the smartphone 200. It is sufficient that the smartphone 200 is connectable to the display unit 206 and includes at least a display control function to control the display on the display unit 206.

The recording medium 210 is configured to record image data output from the image capturing unit 202 and image data received from an information processing apparatus. The recording medium 210 may be configured to be attachable to and detachable from the smartphone 200 or may be provided in the smartphone 200. In other words, it is sufficient that the smartphone 200 at least includes a unit configured to access the recording medium 210.

A connection unit 211 is an interface configured to connect to an image capturing apparatus, such as the digital camera 100, or an external image accumulation apparatus, such as the server 300. The smartphone 200 according to the present embodiment is configured to connect to a plurality of upload destinations (transmission destinations) and exchange data with the image capturing apparatus and the image accumulation apparatus via the connection unit 211. According to the present embodiment, the connection unit 211 includes an interface configured to communicate with the image capturing apparatus and the image accumulation apparatus via a wireless LAN. The control unit 201 controls the connection unit 211, thereby realizing wireless communication with the image capturing apparatus and the image accumulation apparatus.

The digital camera 100 according to the present embodiment may operate at least as a slave device in the infrastructure mode of wireless LAN communication and may join a network formed by a nearby AP.

A public network connection unit 212 is an interface used to perform public wireless communication.

The smartphone 200 may call another device or communicate data via the public network connection unit 212. During a call, the control unit 201 receives and outputs audio signals via a microphone 213 and a speaker 214. According to the present embodiment, the public network connection unit 212 includes an interface configured to perform communication using 3G. The communication method is not limited to 3G and any other communication method may also be used, such as Long Term Evolution (LTE), Worldwide Interoperability for Microwave Access (WiMAX), Asymmetric Digital Subscriber Line (ADSL), Fiber To The Home (FTTH), or so-called 4G. Further, the connection unit 211 and the public network connection unit 212 are not necessarily required to be independent hardware components. For example, a single antenna may be used as the connection unit 211 and the public network connection unit 212.

A near field radio communication unit 215 is an interface configured to establish a short range wireless connection with another external apparatus. The smartphone 200 according to the present embodiment may exchange data with another external apparatus via the near field radio communication unit 215. According to the present embodiment, the near field radio communication unit 215 includes an interface configured to communicate with another external apparatus via Bluetooth®. The control unit 201 controls the near field radio communication unit 215, thereby realizing Bluetooth® communication with another external apparatus.

### Exterior

Next, an exterior of the smartphone 200 will be described. FIG. 3B is a diagram illustrating an example of an exterior of the smartphone 200. A power button 205a, a home button 205b, and a touch panel 205c are operational members included in the operation unit 205. The user may press the home button 205b to suspend use of a running application and display a home screen on the display unit 206 to select another application.

Items corresponding to the applications are arranged on the home screen of the smartphone 200 to enable activation of each application or invocation of an application currently running in the background. For example, an item 221 corresponds to the camera communication application configured to enable the smartphone 200 to communicate with the digital camera 100 according to the present embodiment. An item 222 corresponds to an image display application configured to enable the user to browse an image stored in the smartphone 200. An item 223 corresponds to a social networking service (SNS) application configured to communicate with an external server and share an image, text, and the like with another user.

According to the present embodiment, the camera communication application is an application provided by the manufacturer of the digital camera 100 through an application distribution site. Further, the image display application is an application pre-installed on the smartphone 200 (i.e., an application pre-installed on the OS of the smartphone 200). The SNS application is an application provided by the developer of the SNS application through an application distribution site.

For example, in a case where the item 221 on the home screen is pressed (touched) by the user, if the camera communication application has not been activated, the camera communication application is activated anew, and a function selection screen 501, which will be described below, is displayed. In a case where the application is currently running in the background, the running application is brought to the foreground without starting the application again, and the screen is re-displayed.

Further, on the smartphone 200, an application may be switched or executed without going through the home screen by inputting a specific instruction to the OS. In this case, an application running when the specific instruction is input is brought to the background. Then, an application for which an instruction to switch is issued is activated anew or is brought from the background to the foreground and operates.

### Description of Upload Log Information

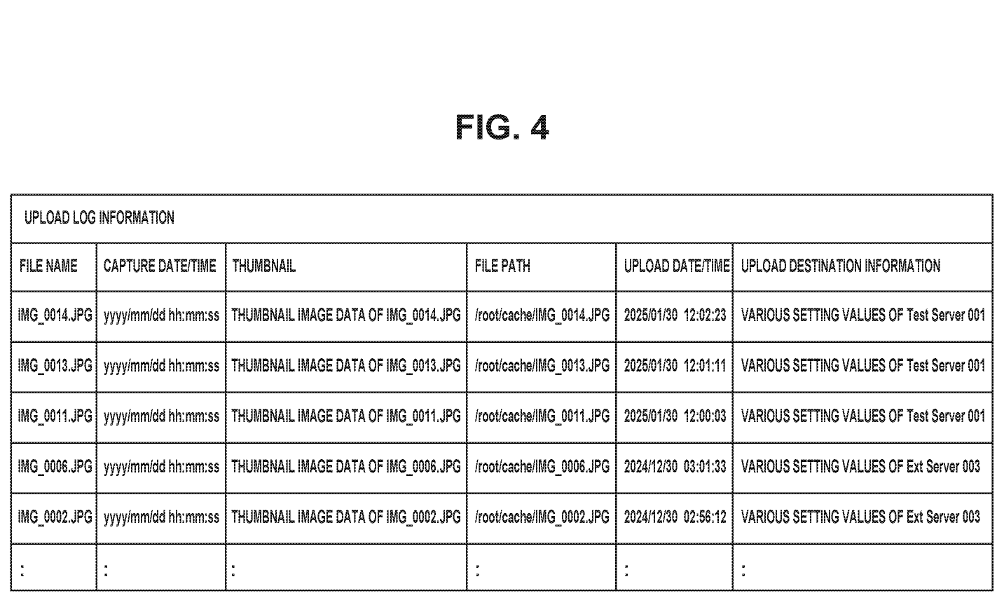

A data format of upload log information stored in the smartphone 200 according to the present embodiment will be described with reference to FIG. 4. According to the present embodiment, the term “download” refers to a process in which the smartphone 200 as the main entity receives an image file from the digital camera 100 and stores the received image file in a download area of the non-volatile memory 203 of the smartphone 200.

Further, the “upload” refers to a process in which the smartphone 200 transmits an image file received from the digital camera 100 or an image file stored in a dedicated folder of the non-volatile memory 203 of the smartphone 200 to the server 300.

As illustrated in FIG. 4, the upload log information includes a file name, capture date/time, thumbnail, file path, upload date/time, and upload destination information, and stores these items for each uploaded image file. The smartphone 200 stores the upload log information including the transmission date (upload date) that is within a range specified by the user, and deletes the upload log information including the transmission date that is outside the range specified by the user.

The three items, the file name, the capture date/time, and the thumbnail, are data or information used to identify each image file on an upload log screen 528, which will be described below. According to the present embodiment, the three items are used as information for file identification because an image file captured by the digital camera 100 is primarily handled, but considering other cases such as a case where data other than an image is handled, other information or data may be employed for identification.

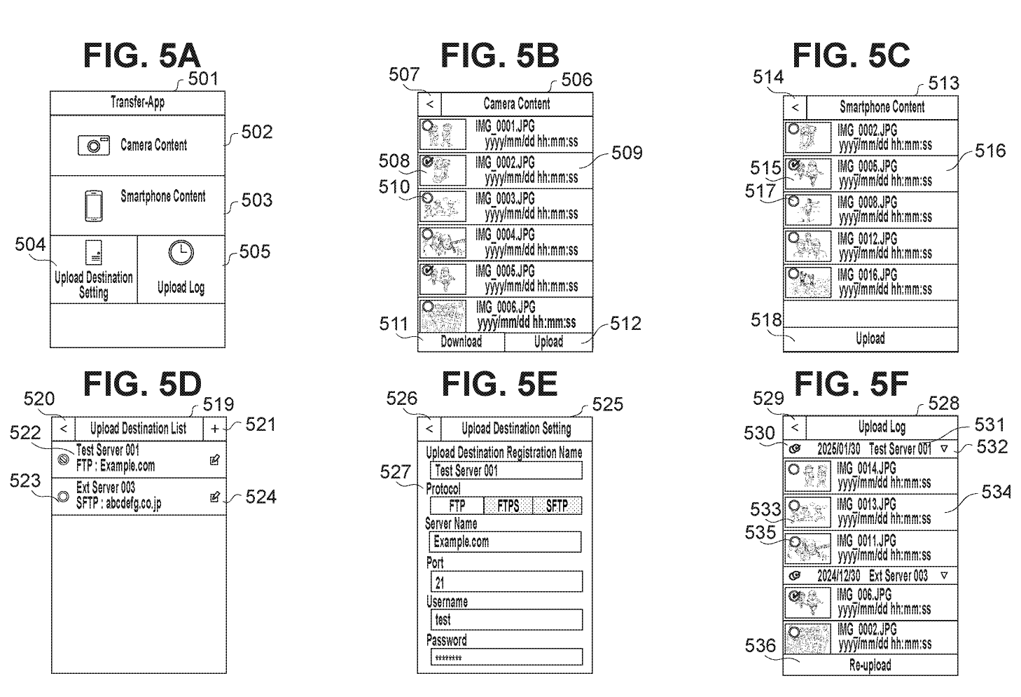

The file name stores a name for each file. The capture date/time stores capture date/time information for each image and is included in metadata of the file. The thumbnail stores thumbnail image data for each image and is included in the metadata of the file. The file path stores data indicating a path of main data of the image file stored in the non-volatile memory 203 of the smartphone 200. The upload date/time stores upload execution date/time information. The upload destination information is a set of various setting values for designating an upload destination settable on an upload destination setting screen 525, which will be described below. Examples of various setting values will be described below with reference to FIG. 5E.

The smartphone 200 generates the upload log screen 528, which will be described below, in FIG. 5F based on the above-described upload log information and re-uploads an image file selected on the upload log screen 528 by the user.

### Description of the Camera Communication Application

Next, forms of the camera communication application will be described with reference to FIGS. 5A to 5F. FIGS. 5A to 5F are schematic diagrams illustrating display states of operation screens and functions of the camera communication application.

### Regarding the Function Selection Screen 501

The function selection screen 501 in FIG. 5A is a screen displayed in a case where the item 221 is selected by the user on the smartphone 200 connected to the digital camera 100 after the camera communication application is activated.

The function selection screen 501 includes a camera content button 502, a smartphone content button 503, an upload destination setting button 504, and an upload log button 505.

### Camera Content Screen 506

When the camera content button 502 is pressed by the user, a transition to a camera content screen 506 illustrated in FIG. 5B occurs. Upon transition to the camera content screen 506, image information about image files recorded in the digital camera 100 is acquired, and a list of information for identifying each image file included in the image information is displayed.

A thumbnail 508 is an area configured to display a preview of thumbnail image data for identifying each image file included in the image information. File information 509 is an area configured to display file name information and capture date/time information for identifying each image file included in the image information.

The camera content screen 506 further includes a return button 507, a checkbox 510, a download button 511, and an upload button 512, in addition to the thumbnail 508 and the file information 509.

When the return button 507 is pressed by the user, a transition to the function selection screen 501 occurs.

When the checkbox 510 is pressed by the user, the corresponding image file is selected as an image file to be downloaded to the smartphone 200 or uploaded to the server 300 from the image files acquired from the digital camera 100. In other words, the user may select an image file to be downloaded to the smartphone 200 or uploaded to the server 300 after verifying the preview content of the thumbnail 508.

When the download button 511 is pressed by the user, a process starts in which body data of the image file associated with the selected thumbnail 508 is acquired from the digital camera 100 and stored in the download area of the non-volatile memory 203 of the smartphone 200.

When the upload button 512 is pressed by the user, a process starts in which body data of the image file associated with the selected thumbnail 508 is acquired from the digital camera 100 and transmitted (uploaded) to a set transmission destination. In this case, pressing the upload button 512 by the user starts transmission of each selected image file to the set transmission destination in order. Specifically, the selected image files are transmitted in order from the newest capture date/time to the set transmission destination.

Further, prior to transmission of the body data of the image file associated with the selected thumbnail 508 to the set transmission destination, the upload log information for the image file is updated. Then, the body data of the image file is stored in a cache area of the non-volatile memory 203 of the smartphone 200. The body data of the image file stored in the cache area of the non-volatile memory 203 of the smartphone 200 is used during re-transfer.

### Smartphone Content Screen 513

When the smartphone content button 503 is pressed by the user, a transition to a smartphone content screen 513 illustrated in FIG. 5C occurs. The smartphone content screen 513 is a screen configured to display a list of image files stored in the download area of the non-volatile memory 203 of the smartphone 200. Upon initial transition to the smartphone content screen 513, image information about each image file stored in the download area of the non-volatile memory 203 of the smartphone 200 is acquired. Then, a list of information for identifying each image file included in the image information is displayed.

A thumbnail 515 is an area configured to display a preview of thumbnail image data for identifying each image file included in the image information. File information 516 is an area configured to display file name information and capture date/time information for identifying each image file included in the image information.

The smartphone content screen 513 further includes a return button 514, a checkbox 517, and an upload button 518, in addition to the thumbnail 515 and the file information 516.

When the return button 514 is pressed by the user, a transition to the function selection screen 501 occurs.

When the checkbox 517 is pressed by the user, the corresponding image file is selected as an image file to be uploaded to the server 300 from the image files stored in the download area of the non-volatile memory 203 of the smartphone 200. In other words, the user may select an image file to be uploaded to the server 300 after verifying the preview content of the thumbnail 515.

When the upload button 518 is pressed by the user, a process starts in which body data of the image file associated with the selected thumbnail 515 is read from the non-volatile memory 203 of the smartphone 200 and transmitted (uploaded) to a set transmission destination. In this case, pressing the upload button 512 by the user starts transmission of each selected image file to the set transmission destination in order. Specifically, the selected image files are transmitted in order from the newest capture date/time to the set transmission destination.

Further, prior to transmission of the body data of the image file associated with the selected thumbnail 515 to the set transmission destination, the upload log information for the image file is updated.

### Upload Destination List Screen 519

When the upload destination setting button 504 is pressed by the user, a transition to an upload destination list screen 519 illustrated in FIG. 5D occurs. The upload destination list screen 519 displays a list of upload destinations stored in the smartphone 200. The upload destinations are pre-registered by the user. A method for pre-registering an upload destination will be described.

A new registration button 521 is a button used to register a new upload destination. When the new registration button 521 is pressed by the user, a transition to the upload destination setting screen 525 illustrated in FIG. 5E occurs in a state where all setting values of all items are empty. The upload destination setting screen 525 is a screen for inputting a setting value of an upload destination to be registered.

A setting value input area 527 is an area where a setting value of a server to be registered as an upload destination is input. According to the present embodiment, an arbitrary character string is input as an upload destination registration name for identifying the upload destination. A protocol is selectable from the File Transfer Protocol (FTP), File Transfer Protocol over Secure Sockets Layer (SSL)/Transport Layer Security (TLS) (FTPS), and Secure Shell (SSH) File Transfer Protocol (SFTP). The setting values of items (server name, port, username, password) below the protocol are changed dynamically based on the selected protocol.

In FIG. 5E, some input items required when FTP is selected are displayed. While a server name, port, username, and password are displayed as examples, the items are not limited to the examples, and items required for file transfer based on various protocols are displayed. The protocols and related input items are not limited to those described above, and necessary information may be set for various protocols for transferring a file to the server.

Further, the upload destination setting screen 525 includes a return button 526. When the return button 526 is pressed by the user, a transition to the upload destination list screen 519 occurs.

The upload destination list screen 519 further includes a return button 520, upload destination information 522, a radio button 523, and an edit button 524, in addition to the new registration button 521.

When the return button 520 is pressed by the user, a transition to the function selection screen 501 occurs.

The upload destination information 522 displays the upload destination registration name and the server name set for the corresponding upload destination as information for identifying the upload destination.

When the radio button 523 is pressed by the user, the corresponding upload destination is selected. The selected upload destination is stored as an upload destination for an image file uploaded from the camera content screen 506 or the smartphone content screen 513.

When the edit button 524 is pressed by the user, a transition to the upload destination setting screen 525 for editing a setting of a previously registered upload destination occurs. The upload destination setting screen 525 displayed as a result of pressing the edit button 524 is in a state where setting values that have been set are input for all items.

### Upload Log Screen 528

When the upload log button 505 is pressed by the user, a transition to the upload log screen 528 illustrated in FIG. 5F occurs. The upload log screen 528 is a screen generated based on the upload log information stored in the smartphone 200.

An image previously transmitted (uploaded) to the server 300 can be re-transmitted (re-uploaded) to the server 300 by selecting the image file on the upload log screen 528 by the user. In this case, it is important to group the images previously transmitted to the server 300 (classify the images into sections) based on a matching combination of the transmission date and the transmission destination (the registration name of the transmission destination) and then display the images. For example, a camera operator may capture images at a plurality of sites on the same day and deliver the image files via transmission to a plurality of transmission destinations on the same day. In this case, the transmitted image file may be re-transmitted to the same transmission destinations after delivery due to trouble such as a transmission error caused by a network condition or a failure of a transmission destination server. When the upload logs of the image files are displayed, if the image files are merely displayed in order of transfer date/time, it becomes difficult to identify the transmission destination associated with each image file, which increases the effort required to locate an image file to be re-transmitted. Thus, image files having a matching combination of the transmission date and the transmission destination (the registration name of the transmission destination) are grouped (classified into sections) and then displayed as image file groups, thereby allowing the user to collectively view image files transmitted to a specific transmission destination on a specific date. This reduces the effort required to re-transmit a previously transmitted image file to the same transmission destination.

The upload log screen 528 includes a return button 529, a section-level select-all button 530, section information 531, a section open/close button 532, a thumbnail 533, file information 534, a checkbox 535, and a re-upload button 536.

When the return button 529 is pressed by the user, a transition to the function selection screen 501 occurs.

When the section-level select-all button 530 is pressed by the user, the state of the checkbox 535 of each image file included in the corresponding image file group is updated. In other words, in a case where the section-level select-all button 530 is pressed by the user in a state where an unselected image file exists in the image file group, all image files included in the image file group are set to a selected state. On the other hand, in a case where the section-level select-all button 530 is pressed by the user in a state where all image files included in the image file group are selected, all the image files included in the image file group are set to an unselected state.

The section information 531 includes the transmission date and the transmission destination (the registration name of the transmission destination) associated with each image file group. A display area of the upload log screen 528 is divided for each group, and the section information 531 is displayed at a leading portion of the corresponding display area. Specifically, the transmission date and the transmission destination are displayed at the leading portion of the display area in order, with the transmission date displayed first. Since the number of characters is variable for the transmission destination and fixed for the transmission date, displaying the transmission date and the transmission destination in this order improves visibility. Further, when the transmission date and the transmission destination are displayed in order, the transmission date is easy to recognize whereas the transmission destination is difficult to recognize. Thus, the transmission destination may be displayed with greater emphasis than the transmission date. Specifically, the characters of the transmission destination may be enlarged, bolded, and/or displayed in a color different from the transmission date.

Each display area displays the section-level select-all button 530, the section information 531, the section open/close button 532, the thumbnail 533, the file information 534, and the checkbox 535. The upload log screen 528 displays the plurality of files for each group in descending order of the transmission dates of the groups. As described above, according to the present embodiment, the grouped image files are displayed in descending order of transmission date. However, this is not a limiting display method. For example, the image files may be displayed in descending order of importance (upscaled, resized, tilt adjusted, International Press Telecommunications Council (IPTC) metadata assigned, protected, rating assigned, audio memo attached, high image quality, or the like).

In a case where a plurality of groups having the same transmission date exists, the plurality of groups is displayed in descending order of transmission times of the files included in the groups. The newest transmission time in the group is used to determine a display order. For example, in a case where an image file A is transmitted to a transmission destination A, an image file B is transmitted to a transmission destination B, and an image file C is transmitted to the transmission destination A in this order on the same day, the image files A and C are classified into a group A, and the image file B is classified into a group B, based on the transmission dates and the transmission destinations. Further, the display order of the groups A and B on the upload log screen 528 is determined based on the transmission time of the image file C of the group A and the transmission time of the image file B of the group B so that the group A is displayed before the group B. Even in a case where a plurality of groups having the same transmission date exists, only the transmission date and the transmission destination are displayed as the section information 531 on the upload log screen 528.

Further, in a case where a plurality of groups having the same transmission date exists, the plurality of groups may be displayed in an order beginning with a group corresponding to a transmission destination set by the user on the upload destination list screen 519. By displaying the groups in an order beginning with a group corresponding to the set transmission destination, an image to be re-uploaded to the set transmission destination can be viewed at once.

In a case where the section open/close button 532 is pressed by the user, it becomes possible to switch each image file included in the image file group classified into the section between displayed and hidden states. In a case where the section open/close button 532 is pressed by the user and an image file included in the image file group classified into the section is switched to the hidden state, the section-level select-all button 530 is also hidden. In other words, only the section information 531 is displayed. However, even in a case where an image file included in the image file group classified into the section or the section-level select-all button 530 is hidden, an image file in the image file group that is selected by the user by pressing the checkbox 535 remains in the selected state.

The thumbnail 533 is an area configured to display a preview of thumbnail image data included in the upload log information for identification of each image file. The file information 534 is an area configured to display the file name and capture date/time information included in the upload log information for identification of each image file.

When the checkbox 535 is pressed by the user, the corresponding image file is selected for re-transmission.

When the re-upload button 536 is pressed by the user, a process starts in which the body data of the selected image file is read from the file path stored in the upload log information and transmitted to the transmission destination stored in the upload log information.

Further, in a case where image files with different transmission dates but the same transmission destination are selected as image files to be re-transmitted, the image files may be collectively transmitted for each transmission date, or the image files may be collectively transmitted for each transmission destination. In a case where the image files are collectively transmitted for each transmission destination, an order of the transmission destinations is determined as follows. For example, the transmission destinations are sorted in descending order of the number of selected image files, in descending order of total size of selected image files, in descending order of upload frequency for each transmission destination, or the like. Further, for example, the transmission destinations are sorted in descending order of importance (upscaled, resized, tilt adjusted, IPTC metadata assigned, protected, rating assigned, audio memo attached, high image quality, or the like).

In a case where a selected image file is to be transmitted from the camera content screen 506 or the smartphone content screen 513 to the set transmission destination, a confirmation screen is displayed prior to transmission to prompt the user to confirm the set transmission destination and the selected image file. On the other hand, in a case where the selected image file is to be re-transmitted to the set transmission destination, the upload log screen 528 does not display a confirmation screen configured to prompt the user to confirm a set re-transmission destination and the selected image file prior to transmission.

Furthermore, a filtering function may be executed on the upload log screen 528. The filtering function is configured to filter the previously uploaded image files based on upload states and then display the image files. Examples of the upload states include the following three states: uploaded, upload failed, and upload cancelled.

The upload log screen 528 displays a filter button (not illustrated). When the filter button is pressed by the user, a transition to a filter setting screen (not illustrated) occurs. Unless the user selects “all” as a target on the filter setting screen, a display is presented to allow uploaded, upload failed, or upload cancelled to be selected. At this time, in a case where one of the upload states is selected by the user and a complete button of the filter setting screen is pressed by the user, only information about image files corresponding to the selected upload state matching the filter being applied is displayed. In this case, the information about image files is displayed without grouping the image files by transmission date and transmission destination. When the user selects “all” as a target, the upload states such as uploaded, upload failed, and upload cancelled are hidden.

### Case where an Image File is Uploaded from the Digital Camera 100 to the Server 300 via the Smartphone 200

### Process Sequence

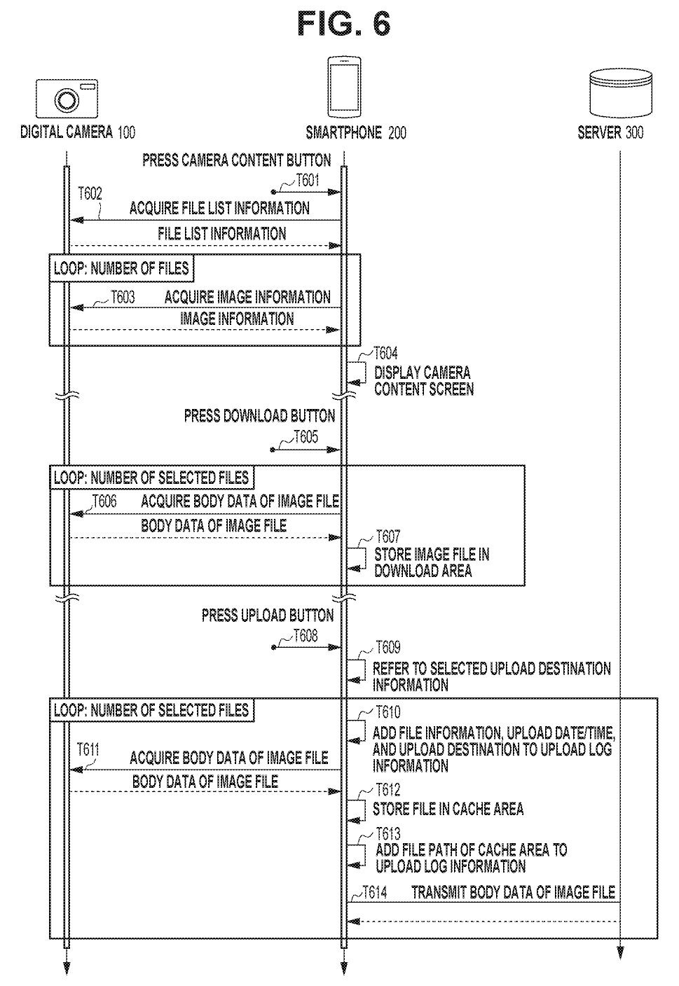

FIG. 6 is a diagram illustrating a process sequence in which an image file is uploaded from the digital camera 100 to the server 300 via the smartphone 200. The process sequence is realized by the control unit 201 of the smartphone 200 by reading a program stored in the non-volatile memory 203 and executing the read program. Further, the process is started in a case where the item 221 of the smartphone 200 is selected by the user to activate the camera communication application and the function selection screen 501 is displayed.

In step T601, the camera content button 502 of the function selection screen 501 is pressed by the user.

In step T602, the control unit 201 of the smartphone 200 issues a file list information acquisition request to the digital camera 100 to acquire file list information recorded in the digital camera 100. Then, the control unit 201 of the smartphone 200 acquires the file list information. According to the present embodiment, the file list information is information describing a path list of image files recorded in the recording medium 110 of the digital camera 100. The file list information is not limited thereto, as long as the file list information is able to identify an image file.

In step T603, the control unit 201 of the smartphone 200 refers to the file list information acquired in step T602 and issues an image information acquisition request to the digital camera 100. Then, the control unit 201 of the smartphone 200 acquires image information about each image file. The process of step T603 is repeated a number of times corresponding to the number of image files recorded in the digital camera 100.

In step T604, the control unit 201 of the smartphone 200 refers to the image information about each image file acquired in step T603 and displays the camera content screen 506. As illustrated in FIG. 5B, the camera content screen 506 displays the thumbnail 508 and the file information 509 for each image file in a list format. Furthermore, the checkbox 510 is displayed in association with each thumbnail 508, thereby allowing the user to select an image file. The selected state with respect to the checkbox 510 is stored until the next time the function selection screen 501 is displayed.

In step T605, the download button 511 of the camera content screen 506 is pressed by the user.

In step T606, the control unit 201 of the smartphone 200 issues a request to the digital camera 100 to acquire body data of the selected image file. Then, the control unit 201 of the smartphone 200 acquires the body data of the selected image file.

In step T607, the control unit 201 of the smartphone 200 stores the acquired body data of the image file in the download area of the non-volatile memory 203. The processes of steps T606 and T607 are repeated a number of times corresponding to the number of selected image files.

In step T608, the upload button 512 is pressed by the user.

In step T609, the control unit 201 of the smartphone 200 refers to the upload destination information 522 selected in advance by the user.

In step T610, the control unit 201 of the smartphone 200 adds the thumbnail 508, the file information 509 including the file name and the capture date/time, the upload destination information 522, and the current date/time corresponding to the upload date/time to the upload log information and then stores the information.

In step T611, the control unit 201 of the smartphone 200 issues a request to the digital camera 100 to acquire body data of the image file selected as an image file to be uploaded. Then, the control unit 201 of the smartphone 200 acquires the body data of the selected image file.

In step T612, the control unit 201 of the smartphone 200 stores the body data of the image file acquired in step T611 in the cache area of the non-volatile memory 203 of the smartphone 200. The body data of the image file stored in the cache area of the non-volatile memory 203 of the smartphone 200 is used during re-transfer.

In step T613, the control unit 201 of the smartphone 200 adds a file path of the cache area in which the body data of the image file is stored in step T612 to the upload log information.

In step T614, the control unit 201 of the smartphone 200 transmits (uploads) the body data of the image file acquired in step T611 to the server 300. The processes of steps T610 to T614 are repeated a number of times corresponding to the number of image files selected as an image file to be uploaded.

As described above, the control unit 201 of the smartphone 200 updates the upload log information before an image file selected by the user from an image file downloaded from the digital camera 100 is uploaded to the server 300. Specifically, the thumbnail 508, the file information 509, the upload destination information 522, the current date/time corresponding to the upload date/time, and the file path of the cache area in which the body data of the image file is stored are added to the upload log information.

### Process Flow

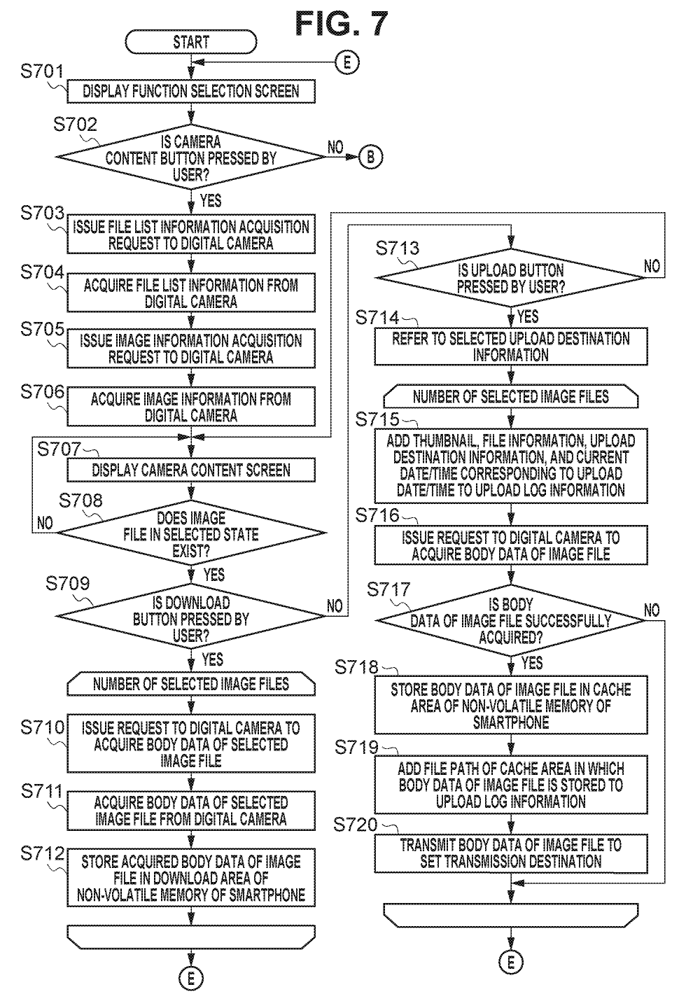

FIG. 7 is a diagram illustrating a process flow in which an image file is uploaded from the digital camera 100 to the server 300 via the smartphone 200. The process flow is a process realized by the control unit 201 of the smartphone 200 by reading a program stored in the non-volatile memory 203 and executing the read program. Further, the process is started in a case where the item 221 of the smartphone 200 is selected by the user to activate the camera communication application.

In step S701, the control unit 201 of the smartphone 200 displays the function selection screen 501 on the display unit 206 of the smartphone 200.

In step S702, the control unit 201 of the smartphone 200 determines whether the camera content button 502 of the function selection screen 501 is pressed by the user. In a case where the control unit 201 determines that the camera content button 502 is pressed (YES in step S702), the processing proceeds to step S703. Otherwise (NO in step S702), the processing proceeds to step S901.

In step S703, the control unit 201 of the smartphone 200 issues a file list information acquisition request to the digital camera 100 to acquire file list information recorded in the digital camera 100.

In step S704, the control unit 201 of the smartphone 200 acquires the file list information from the digital camera 100.

In step S705, the control unit 201 of the smartphone 200 refers to the file list information acquired in step S704 and issues an image information acquisition request to the digital camera 100.

In step S706, the control unit 201 of the smartphone 200 acquires image information about each image file from the digital camera 100.

In step S707, the control unit 201 of the smartphone 200 refers to the image information about each image file acquired in step S706 and displays the camera content screen 506 on the display unit 206 of the smartphone 200.

In step S708, the control unit 201 of the smartphone 200 determines whether an image file in a selected state exists. In other words, the control unit 201 determines whether an image file associated with the checkbox 510 of the camera content screen 506 in a checked state exists. In a case where the control unit 201 determines that an image file in a selected state exists (YES in step S708), the processing proceeds to step S709. Otherwise (NO in step S708), the processing proceeds to step S707.

In step S709, the control unit 201 of the smartphone 200 determines whether the download button 511 of the camera content screen 506 is pressed by the user. In a case where the control unit 201 determines that the download button 511 is pressed (YES in step S709), the processing proceeds to step S710. Otherwise (NO in step S709), the processing proceeds to step S714.

In step S710, the control unit 201 of the smartphone 200 issues a request to the digital camera 100 to acquire body data of the selected image file.

In step S711, the control unit 201 of the smartphone 200 acquires the body data of the selected image file from the digital camera 100.

In step S712, the control unit 201 of the smartphone 200 stores the acquired body data of the image file in the download area of the non-volatile memory 203 of the smartphone 200, and then the processing proceeds to step S701.

In step S713, the control unit 201 of the smartphone 200 determines whether the upload button 512 of the camera content screen 506 is pressed by the user. In a case where the control unit 201 determines that the upload button 512 is pressed by the user (YES in step S713), the processing proceeds to step S714. Otherwise (NO in step S713), the processing proceeds to step S707.

In step S714, the control unit 201 of the smartphone 200 refers to upload destination information selected in advance by the user on the upload destination list screen 519 in FIG. 5D as information about the server 300 as the transmission destination. For example, since the upload destination information 522 is selected in advance by the user on the upload destination list screen 519 in FIG. 5D, the control unit 201 refers to the upload destination information 522.

In step S715, the control unit 201 of the smartphone 200 adds the thumbnail 508, the file information 509 including the file name and the capture date/time, the upload destination information 522, and the current date/time corresponding to the upload date/time to the upload log information and then stores the information.

In step S716, the control unit 201 of the smartphone 200 issues a request to the digital camera 100 to acquire body data of the image file selected as an image file to be uploaded.

In step S717, the control unit 201 of the smartphone 200 determines whether the body data of the image file is successfully acquired. In a case where the control unit 201 determines that the body data of the image file is successfully acquired (YES in step S717), the processing proceeds to step S718. Otherwise (NO in step S717), the processing proceeds to step S701.

In step S718, the control unit 201 of the smartphone 200 stores the body data of the image file acquired in step S718 in the cache area of the non-volatile memory 203 of the smartphone 200. The body data of the image file stored in the cache area of the non-volatile memory 203 of the smartphone 200 is used during re-transfer.

In step S719, the control unit 201 of the smartphone 200 adds a file path of the cache area in which the body data of the image file is stored in step S719 to the upload log information.

In step S720, the control unit 201 of the smartphone 200 transmits (uploads) the body data of the image file acquired in step S717 to the set transmission destination. The processes of steps S715 to S720 are repeated a number of times corresponding to the number of image files in a selected state in step S708.

### Case where an Image File is Uploaded from the Smartphone 200 to the Server 300

### Process Sequence

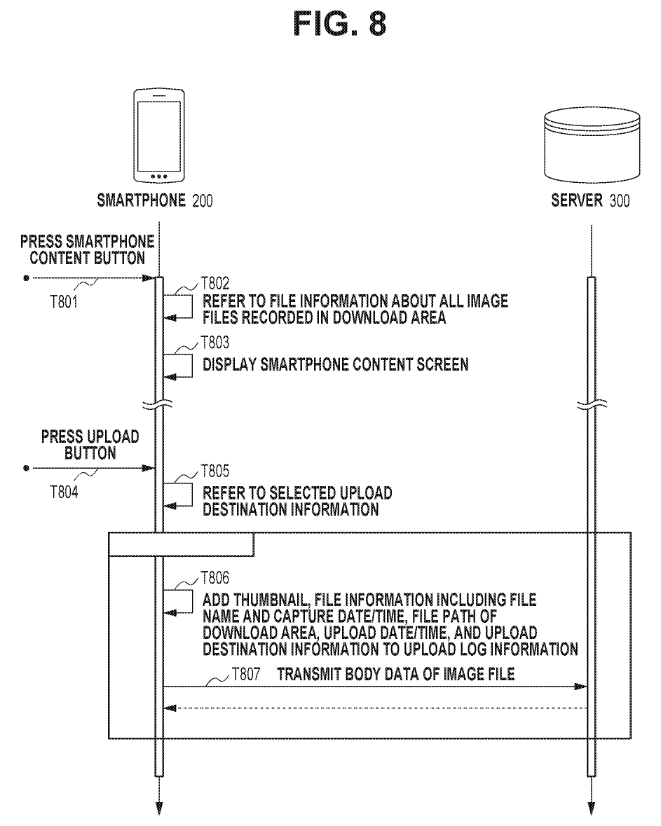

FIG. 8 is a diagram illustrating a process sequence in which an image file is uploaded from the smartphone 200 to the server 300. The process sequence is realized by the control unit 201 of the smartphone 200 by reading a program stored in the non-volatile memory 203 and executing the read program.

Further, the process is started in a case where the item 221 of the smartphone 200 is selected by the user to activate the camera communication application and the function selection screen 501 is displayed.

In step T801, the smartphone content button 503 of the function selection screen 501 is pressed by the user.

In step T802, the control unit 201 of the smartphone 200 refers to all image files recorded in the download area of the non-volatile memory 203 of the smartphone 200.

In step T803, the control unit 201 of the smartphone 200 acquires the thumbnail 515 and the file information 516 including the file name and the capture date/time from metadata of each image file and displays the smartphone content screen 513. The smartphone content screen 513 displays the thumbnail 515 and the file information 516 of each image file in a list format, and the checkbox 517 is further displayed in association with each image file, thereby allowing the user to select an image file. The selected state with respect to the checkbox 517 is stored until the next time the function selection screen 501 is displayed.

In step T804, the control unit 201 of the smartphone 200 determines that the upload button 518 of the smartphone content screen 513 is pressed.

In step T805, the control unit 201 of the smartphone 200 refers to the upload destination information 522 selected in advance by the user.

In step T806, the control unit 201 of the smartphone 200 adds the following information to the upload log information about the image file selected as an image file to be uploaded by the user and stores the information. Specifically, the thumbnail 515, the file information 516 including the file name and the capture date/time, the upload destination information 522, the current date/time corresponding to the upload date/time, and the file path of the download area are added and stored.

In step T807, the control unit 201 of the smartphone 200 reads the body data of the image file selected as an image file to be uploaded by the user from the download area and transmits (uploads) the read body data to the server 300. Then, the process is terminated.

The processes of steps T806 and T807 are repeated a number of times corresponding to the number of image files associated with the checkbox 517 in a selected state on the smartphone content screen 513.

### Process Flow

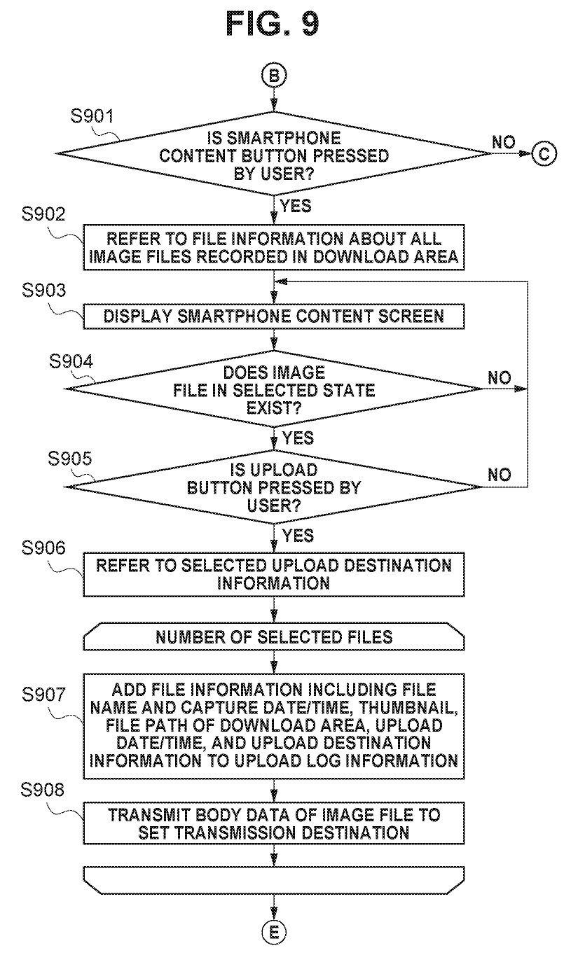

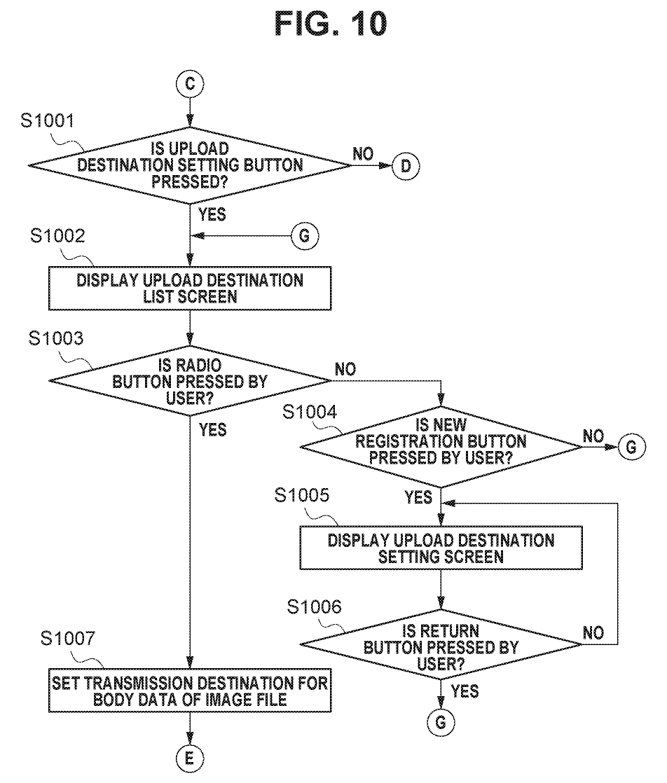

FIGS. 9 and 10 are diagrams illustrating process flows in which an image file is uploaded from the smartphone 200 to the server 300. The process flows are processes realized by the control unit 201 of the smartphone 200 by reading a program stored in the non-volatile memory 203 and executing the read program.

Further, the processes are started in a case where the item 221 of the smartphone 200 is selected by the user to activate the camera communication application.

In step S901, the control unit 201 of the smartphone 200 determines whether the smartphone content button 503 of the function selection screen 501 is pressed by the user.

In a case where the control unit 201 determines that the smartphone content button 503 is pressed (YES in step S901), the processing proceeds to step S902. Otherwise (NO in step S901), the processing proceeds to step S1001.

In step S902, the control unit 201 of the smartphone 200 refers to the thumbnail 515 and the file information 516 of each image file from metadata of all image files recorded in the download area of the non-volatile memory 203 of the smartphone 200. The file information 516 includes the file name and the capture date/time.

In step S903, the control unit 201 of the smartphone 200 displays the smartphone content screen 513. The smartphone content screen 513 displays the thumbnail 515 and the file information 516 of each image file in a list format.

In step S904, the control unit 201 of the smartphone 200 determines whether an image file in a selected state exists on the smartphone content screen 513. In a case where the control unit 201 determines that an image file in a selected state exists (YES in step S904), the processing proceeds to step S905. Otherwise (NO in step S904), the processing proceeds to step S903.

In step S905, the control unit 201 of the smartphone 200 determines whether the upload button 518 is pressed by the user. In a case where the control unit 201 determines that the upload button 518 is pressed by the user (YES in step S905), the processing proceeds to step S906. Otherwise (NO in step S905), the processing proceeds to step S903.

In step S906, the control unit 201 of the smartphone 200 refers to upload destination information selected in advance by the user on the upload destination list screen 519 in FIG. 5D as information about the server 300 as the upload destination. For example, since the upload destination information 522 is selected in advance by the user on the upload destination list screen 519 in FIG. 5D, the control unit 201 refers to the upload destination information 522.

In step S907, the control unit 201 of the smartphone 200 adds the following information to the upload log information and stores the information. Specifically, the thumbnail 508, the file information 509 including the file name and the capture date/time, the upload destination information 522, the current date/time corresponding to the upload date/time, and the file path of the download area are added and stored.

In step S908, the control unit 201 of the smartphone 200 reads the body data of the image file selected as an image file to be uploaded by the user from the download area and transmits (uploads) the read body data to the set transmission destination. Then, the processing proceeds to step S701.

The processes of steps S907 and S908 are repeated a number of times corresponding to the number of image files in a selected state in step S904.

In step S1001, the control unit 201 of the smartphone 200 determines whether the upload destination setting button 504 is pressed by the user. In a case where the control unit 201 determines that the upload destination setting button 504 is pressed (YES in step S1001), the processing proceeds to step S1002. Otherwise (NO in step S1001), the processing proceeds to step S1201.

In step S1002, the control unit 201 of the smartphone 200 displays the upload destination list screen 519.

In step S1003, the control unit 201 of the smartphone 200 determines whether the radio button 523 is pressed by the user. In a case where the control unit 201 determines that the radio button 523 is pressed by the user (YES in step S1003), the processing proceeds to step S1007. Otherwise (NO in step S1003), the processing proceeds to step S1004.

In step S1004, the control unit 201 of the smartphone 200 determines whether the new registration button 521 is pressed by the user. In a case where the control unit 201 determines that the new registration button 521 is pressed by the user (YES in step S1004), the processing proceeds to step S1005. Otherwise (NO in step S1004), the processing proceeds to step S1002.

In step S1005, the control unit 201 of the smartphone 200 displays the upload destination setting screen 525 and receives an input to each item.

In step S1006, the control unit 201 of the smartphone 200 determines whether the return button 526 is pressed by the user. In a case where the control unit 201 determines that the return button 526 is pressed by the user (YES in step S1006), the processing proceeds to step S1002. Otherwise (NO in step S1006), the processing proceeds to step S1005.

In step S1007, the control unit 201 of the smartphone 200 sets a transmission destination (upload destination) for the body data of the image file.

### Process in which an Image File is Re-Uploaded from the Upload Log Screen 528

### Process Sequence

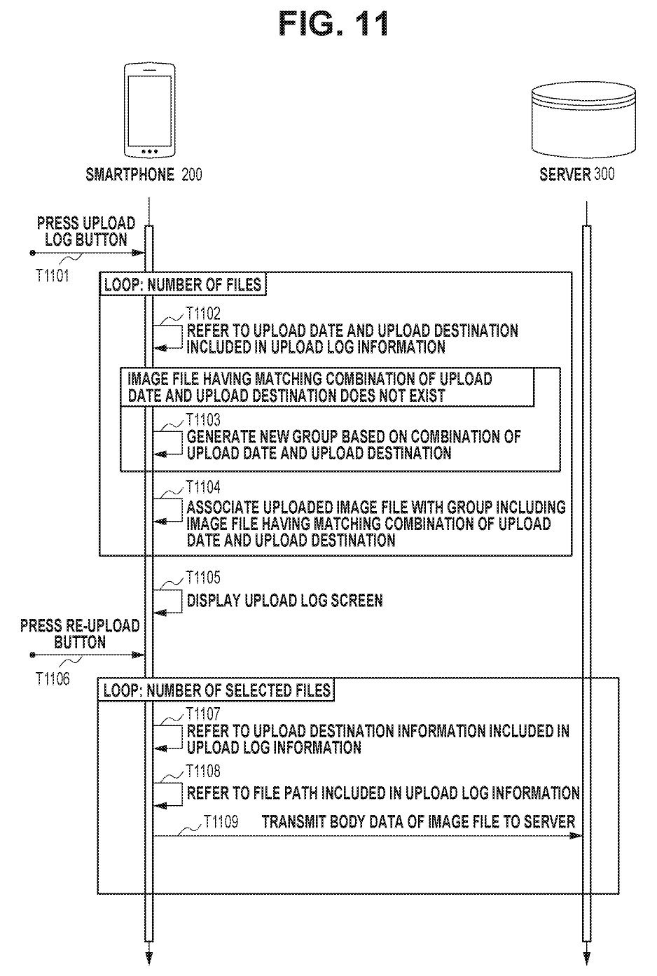

FIG. 11 is a diagram illustrating a process sequence in which an image file is re-uploaded from the upload log screen 528. The process sequence is realized by the control unit 201 of the smartphone 200 by reading a program stored in the non-volatile memory 203 and executing the read program. Further, the process is started in a case where the item 221 of the smartphone 200 is selected by the user to activate the camera communication application and the function selection screen 501 is displayed.

In step T1101, the upload log button 505 of the function selection screen 501 is pressed by the user.

In step T1102, the control unit 201 of the smartphone 200 refers to the upload date and the upload destination information 522 (the transmission date and the transmission destination) included in the upload log information associated with the uploaded image file. At that time, in a case where an image file having a matching combination of the upload date and the upload destination (the transmission date and the transmission destination) does not exist, the processing proceeds to step T1103.

In a case where an image file having a matching combination of the upload date and the upload destination (the transmission date and the transmission destination) exists, the processing proceeds to step T1104.

In step T1103, the control unit 201 of the smartphone 200 generates a new group based on the combination of the upload date and the upload destination (the transmission date and the transmission destination).

In step T1104, the control unit 201 of the smartphone 200 associates the uploaded image file with a group including an image file having a matching combination of the upload date and the upload destination.

The processes of steps T1102 to T1104 are repeated a number of times corresponding to the number of uploaded image files. Consequently, a group of image files having a matching combination of the upload date and the upload destination is generated.

In step T1105, the control unit 201 of the smartphone 200 generates the upload log screen 528 (FIG. 5F) by generating a section for each group and displaying files of the same group in each section, and displays the upload log screen 528 (FIG. 5F).

Further, as illustrated by way of example in FIG. 5F, the upload log screen 528 displays the thumbnail 533 and the file information 534 including the file name and the capture date/time for each image file in a list format based on the upload log information associated with each uploaded image file. Furthermore, in addition to positioning the checkbox 535 in association with the corresponding thumbnail 533, the section-level select-all button 530 configured to receive a user instruction is positioned in each section. This allows the user to select each image file individually and all files in the section collectively. A selected state with respect to the section-level select-all button 530 or the checkbox 535 is stored until the next time the function selection screen 501 is displayed.

In step T1106, the re-upload button 536 of the upload log screen 528 is pressed by the user.

In step T1107, the control unit 201 of the smartphone 200 refers to the upload log information and refers to the upload destination information 522 associated with the selected image file.

In step T1108, the control unit 201 of the smartphone 200 refers to the upload log information and refers to the file path associated with the selected image file. Specifically, in a case where an image file is uploaded from the digital camera 100 to the server 300 via the smartphone 200, the control unit 201 refers to the file path of the cache area of the non-volatile memory 203 of the smartphone 200. In a case where an image file is uploaded from the smartphone 200 to the server 300, the control unit 201 refers to the file path of the download area of the non-volatile memory 203 of the smartphone 200.

In step T1109, the control unit 201 of the smartphone 200 reads the body data of the image file from the file path referred to in step T1108 and transmits the body data to the server 300 based on the upload destination information 522 referred to in step T1107.

The processes of steps T1107 to T1109 are repeated a number of times corresponding to the number of selected image files.

As described above, an image file selected on the upload log screen 528 may be re-uploaded to the same upload destination (transmission destination), i.e., the same server 300, by referring to the upload log information.

### Process Flow

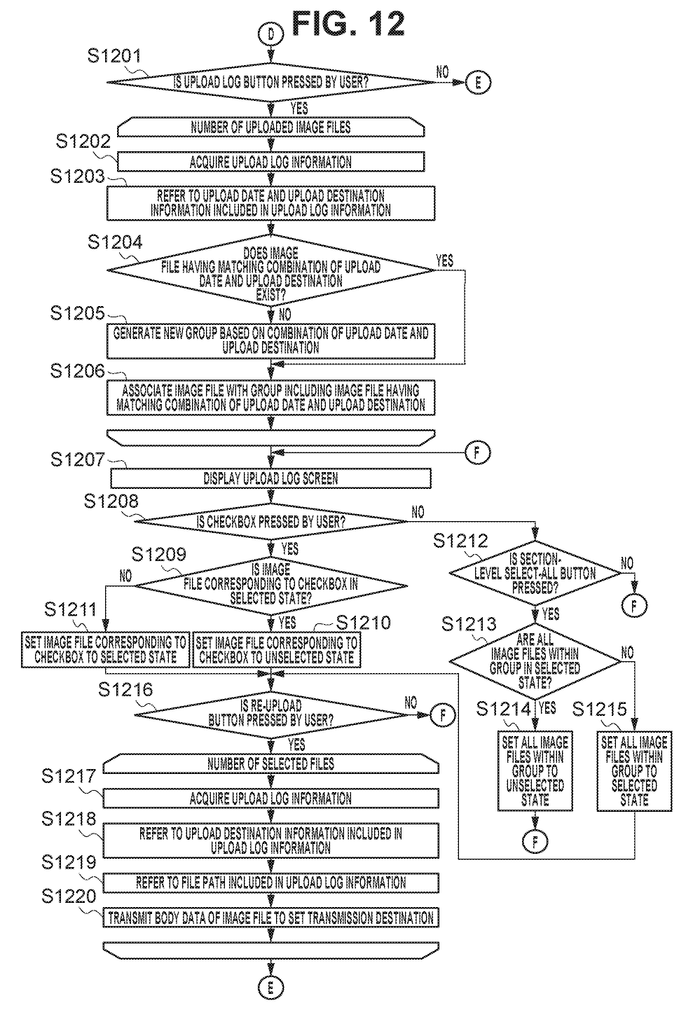

FIG. 12 is a diagram illustrating a process flow in which an image file is re-uploaded from the upload log screen 528. The process flow is a process realized by the control unit 201 of the smartphone 200 by reading a program stored in the non-volatile memory 203 and executing the read program. Further, the process is started in a case where the item 221 of the smartphone 200 is selected by the user to activate the camera communication application.

In step S1201, the control unit 201 of the smartphone 200 determines whether the upload log button 505 of the function selection screen 501 is pressed by the user. In a case where the control unit 201 determines that the upload log button 505 is pressed by the user (YES in step S1201), the processing proceeds to step S1202. Otherwise (NO in step S1201), the processing proceeds to step S701.

In step S1202, the control unit 201 of the smartphone 200 acquires upload log information about the uploaded image file.

In step S1203, the control unit 201 of the smartphone 200 refers to the upload date and the upload destination information 522 (the transmission date and the transmission destination) included in the upload log information acquired in step S1202.

In step S1204, the control unit 201 of the smartphone 200 determines whether an image file having a matching combination of the upload date and the upload destination (the transmission date and the transmission destination) exists. In a case where an image file having a matching combination of the upload date and the upload destination (the transmission date and the transmission destination) does not exist (NO in step S1204), the processing proceeds to step S1205. Otherwise (YES in step S1204), the processing proceeds to step S1206.

In step S1205, the control unit 201 of the smartphone 200 generates a new group based on the combination of the upload date and the upload destination (the transmission date and the transmission destination).

In step S1206, the control unit 201 of the smartphone 200 associates the uploaded image file with a group including an image file having a matching combination of the upload date and the upload destination.

The processes of steps S1202 to S1206 are repeated a number of times corresponding to the number of uploaded image files. Consequently, a group of image files having a matching combination of the upload date and the upload destination is generated.

In step S1207, the control unit 201 of the smartphone 200 generates the upload log screen 528 (FIG. 5F) by generating a section for each group and displaying files of the same group in each section, and displays the upload log screen 528 (FIG. 5F).

In step S1208, the control unit 201 of the smartphone 200 determines whether the checkbox 535 is pressed by the user. In a case where the control unit 201 determines that the checkbox 535 is pressed by the user (YES in step S1208), the processing proceeds to step S1209. Otherwise (NO in step S1208), the processing proceeds to step S1212.

In step S1209, the control unit 201 of the smartphone 200 determines whether the image file corresponding to the checkbox 535 is in a selected state. In a case where the control unit 201 determines that the image file corresponding to the checkbox 535 is in a selected state (YES in step S1209), the processing proceeds to step S1210. Otherwise (NO in step S1209), the processing proceeds to step S1211.

In step S1210, the control unit 201 of the smartphone 200 sets the image file corresponding to the checkbox 535 to an unselected state.

In step S1211, the control unit 201 of the smartphone 200 sets the image file corresponding to the checkbox 535 to a selected state.

In step S1212, the control unit 201 of the smartphone 200 determines whether the section-level select-all button 530 is pressed by the user. In a case where the control unit 201 determines that the section-level select-all button 530 is pressed by the user (YES in step S1212), the processing proceeds to step S1213. Otherwise (NO in step S1212), the processing proceeds to step S1207.

In step S1213, the control unit 201 of the smartphone 200 determines whether all image files within a group of image files classified into sections are in a selected state. In a case where the control unit 201 determines that not all image files within the group are in a selected state (NO in step S1213), the processing proceeds to step S1215. On the other hand, in a case where the control unit 201 determines that all image files within the group are in a selected state (YES in step S1213), the processing proceeds to step S1214.

In step S1214, the control unit 201 of the smartphone 200 sets all image files within the group to an unselected state, and then the processing proceeds to step S1207.

In step S1215, the control unit 201 of the smartphone 200 sets all image files within the group to a selected state, and then the processing proceeds to step S1216.

In step S1216, the control unit 201 of the smartphone 200 determines whether the re-upload button 536 of the upload log screen 528 is pressed by the user. In a case where the control unit 201 determines that the re-upload button 536 is pressed (YES in step S1216), the processing proceeds to step S1217. Otherwise (NO in step S1216), the processing proceeds to step S1207.

In step S1217, the control unit 201 of the smartphone 200 acquires upload log information about the uploaded image file.

In step S1218, the control unit 201 of the smartphone 200 refers to the upload destination information 522 included in the upload log information acquired in step S1217.

In step S1219, the control unit 201 of the smartphone 200 refers to the file path included in the upload log information acquired in step S1217.

In step S1220, the control unit 201 of the smartphone 200 reads the body data of the image file from the file path referred to in step S1219 and transmits the body data to the set transmission destination based on the upload destination information 522 referred to in step S1218.

Each upload log is stored, and when presented to the user, the upload logs are classified into sections based on the combination of the upload date and the upload destination (the transmission date and the transmission destination) and then displayed, thereby making it easier for the user to view and select a group of files transmitted to a specific transmission destination on a specific date.

This eliminates the need to search for an image to be re-uploaded when the user wishes to re-upload the body data of the image file to the same transmission destination.

According to the present embodiment, the upload logs are classified into sections based on the combination of the transmission date and the transmission destination. However, in a case where, for example, image capturing is performed using different cameras for different scenes, it may be desirable for the camera used to capture each image file to be easily distinguishable in the log list even if the transmission destinations are the same.

Thus, source information (information indicating whether the source is a camera or the smartphone 200, and distinguishable camera device information in a case where the source is a camera) may be added to the combination of the transmission date and the transmission destination, and the upload logs may be classified into sections based on the combination of the source information, the transmission date, and the transmission destination.

The present disclosure makes it possible to improve usability when reviewing an upload log.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-035105, filed March 6, 2025, which is hereby incorporated by reference herein in its entirety.

What is claimed is:

1. An information processing apparatus that connects to a plurality of upload destinations, the information processing apparatus comprising:
one or more memories storing instructions; and
one or more processors that, upon execution of the stored instructions, is configured to:
acquire a plurality of files uploaded from the information processing apparatus to upload destinations and upload log information about upload dates and the upload destinations of the plurality of files;
perform control such that, in a case where an instruction to display an upload log list is issued, the upload log list is displayed based on the acquired upload log information; and
perform control such that files having a matching combination of an upload date and an upload destination are grouped into a same group and the upload log list including a plurality of groups having different upload destinations is displayed on a display.

2. The information processing apparatus according to claim 1, wherein the information processing apparatus is a smartphone.

3. The information processing apparatus according to claim 1, wherein control is performed to divide a display area for each group and display the upload date and the upload destination of each group at a leading portion of a corresponding divided display area.

4. The information processing apparatus according to claim 3, wherein control is performed to display the upload date and the upload destination in an order of the upload date followed by the upload destination.

5. The information processing apparatus according to claim 4, wherein control is performed to display the upload destination more prominently than the upload date.

6. The information processing apparatus according to claim 1, wherein control is performed to display, on the display, the plurality of files for each group in an order of groups having newer upload dates.

7. The information processing apparatus according to claim 6, wherein, in a case where a plurality of groups having a same upload date exists, control is performed to display the plurality of groups in order starting from a group that includes a file with a newer upload time.

8. The information processing apparatus according to claim 6, wherein execution of the stored instructions further configures the one or more processors to:
set an upload destination from among the plurality of upload destinations;
select a file to be uploaded to the set upload destination;
upload the selected file to the set upload destination; and
perform control such that, in a case where a plurality of groups having a same upload date exists, the plurality of groups is displayed in order starting from a group corresponding to the set upload destination.

9. The information processing apparatus according to claim 1, wherein control is performed to display a selection button for receiving a user instruction to select all files included in the same group.

10. The information processing apparatus according to claim 9, wherein control is performed such that, in a case where a file included in a group is displayed, the selection button for selecting all files included in the group is displayed, and, in a case where a file included in a group is hidden, the selection button for selecting all files included in the group is hidden.

11. The information processing apparatus according to claim 9, wherein the one or more processors and the one or more memories are further configured to re-upload a file to the upload destination.

12. The information processing apparatus according to claim 1, wherein execution of the stored instructions further configures the one or more processors to:
set an upload destination from among the plurality of transmission destinations;
select a file to be uploaded to the set upload destination;
upload the selected file to the set upload destination;
store, as upload log information, information about the uploaded file, an upload date, and the upload destination; and
acquire the stored upload log information.

13. The information processing apparatus according to claim 12, wherein the upload log information is stored for a range of upload dates specified by a user, and the upload log information having upload dates not included in the range is deleted.

14. The information processing apparatus according to claim 13, wherein, in displaying the upload log list, control is performed such that all files stored as the upload log information are grouped and displayed on the display.

15. The information processing apparatus according to claim 1, wherein, in displaying the upload log list, control is performed such that, in a case where a filtering function is executed, a file filtered by the filtering function is displayed on the display without grouping.

16. The information processing apparatus according to claim 15,
wherein, in the filtering function, upload states including uploaded, upload failed, and upload cancelled are selectable, and
wherein, by executing the filtering function, control is performed such that a file that matches a selected upload state among the plurality of files included in the upload log information is displayed on the display.

17. A method for controlling an information processing apparatus configured to connect to a plurality of upload destinations, the method comprising:
acquiring a plurality of files uploaded from the information processing apparatus to upload destinations and upload log information about upload dates and the upload destinations of the plurality of files;
performing control such that, in a case where an instruction to display an upload log list is issued, the upload log list is displayed based on the acquired upload log information; and
performing control such that files having a matching combination of an upload date and an upload destination are grouped into a same group, and the upload log list including a plurality of groups having different upload destinations is displayed on a display.

18. A non-transitory computer-readable recording medium recording a program for causing a computer to execute the method for controlling the information processing apparatus according to claim 17.

19. An information processing system including an image capturing apparatus and an information processing apparatus configured to connect to a plurality of upload destinations,
wherein the information processing apparatus is configured to:
acquire a plurality of files uploaded from the information processing apparatus to upload destinations and upload log information about upload dates and the upload destinations of the plurality of files;
perform control such that, in a case where an instruction to display an upload log list is issued, the upload log list is displayed based on the acquired upload log information; and
perform control such that files having a matching combination of an upload date and an upload destination are grouped into a same group and the upload log list including a plurality of groups having different upload destinations is displayed on a display.
